(19) United States
(12) Patent Application Publication
(10) Pub. No.: US 2007/0033809 A1
(43) Pub. Date: Feb. 15, 2007

(54) Combination eating utensil

(76) Inventor: Kamran Shirazi, San Francisco, CA (US)

Correspondence Address: PERKINS COIE LLP, P.O. BOX 2168, MENLO PARK, CA, 94026, US

(21) Appl. No.: 11/200,666

(22) Filed: Aug. 10, 2005

(51) Int. Cl. A47J 43/28

(52) U.S. Cl. 30/147

(57) ABSTRACT

A combination eating utensil comprises: a first eating utensil, a second eating utensil, a third eating utensil and a plurality of connection means for removably engaging the third eating utensil to the first and second eating utensils. The first eating utensil has a first chopstick section and a fork section. The second eating utensil has a second chopstick section and a spoon section, the spoon section mechanically couples to at least a portion of the first chopstick section and the fork section mechanically couples to at least a portion of the second chopstick section to form a receiving space therebetween. The third eating utensil is disposed in the receiving space and mechanically coupled to the first and the second eating utensils.

### FIELD OF THE INVENTION

The present invention relates generally to eating utensils, and more particularly, to a combination of eating utensils.

### BACKGROUND OF THE INVENTION

Different cultures have different food styles. For Oriental foods, such as Chinese and Japanese foods, chopsticks are the major eating utensils, while for Western-style foods, forks, spoons, and knives are the well known eating utensils. However, for a meal (Oriental food, Western-style food, and a combination of the like) each single person must be provided with a whole set of eating utensils including the forks, spoons, knives, chopsticks, and the like, which occupy a lot of space on a table. Moreover, the improper setting of the different eating utensils may destroy the aesthetic appearance of the whole table setting. Also, there is a chance of misplacing a particular eating utensil in a particular set of eating utensils. Furthermore, during trips and journeys in the vacations, more specifically to outdoor locations like mountaineering and trekking, it is really cumbersome to carry different type of eating utensils all the time.

In order to obviate the above drawbacks, numerous combination eating utensils are available that enable the interconnection of forks, spoons, knives, and the like. However, when a lot of eating utensils are interconnected to form a combination eating utensil, the bulk of the combination eating utensil renders it unsuitable for use. Also, some combinations of various eating utensils are difficult to use because of their complex configuration which leads to difficulty in disassembling the eating utensils for use, and to reassemble after they have been disassembled for use. Many other combination eating utensils are expensive to fabricate and may also use large amount of material because of their design peculiarities.

U.S. Pat. No. 6,067,717 discloses a combination utensil tool comprising a common handle with first and second ends with attachable forks, spoons, and knives which can be attached and detached from the common handle. The invention provides two eating utensils (forks, spoons, knives) at two opposite ends of the common handle, and thus is an unsuitable eating utensil for a user who requires a knife and a fork or a spoon separtately in order to cut and grasp the food at the same time. This patent does not disclose the use of the combination utensil tool as chopsticks, and thus is not fit for oriental food.

U.S. Pat. No. 5,791,053 discloses a handle component releasably retaining a food engagement component and also a food handling utensil comprising two food engagement components retained by two handle components, with a spring biasing component connected to the two handle components such that the handle components are held away from each other in a resting mode and are hand movable towards each other for use. This patent involves a complex configuration and is complicated in terms of assembling and disassembling the utensils during use

U.S. Pat. No. 5,056,173 discloses a combination fork and chopstick eating utensil in which the handle is in the form of a chopstick so that a person can use either the fork portion or the chopsticks portion for picking up food. The invention does not provide the use of the combination eating utensil either as a spoon or a knife. A spoon is a popular eating utensil for picking up food while a knife is a popular eating utensil for cutting the food, and thus the invention is unsuitable where spoon and/or knife is required for eating food and thereby does not efficiently serve the purpose of a combination eating utensil.

The prior art does not provide a combination eating utensil that provides all the major eating utensils, namely, forks, spoons, knives, and chopsticks in a single combination in a simple, effective and easy-to-use manner. Accordingly, the present scenario is punctuated by an emerging need to address all the shortfalls of the prior arts and to provide a single combination eating utensil that provides all the major eating utensils (i.e., a fork, spoon, a knife, and chopsticks), which can be disassembled in a simple and effective manner and for easy usage of the eating utensils.

### SUMMARY OF THE INVENTION

In view of the foregoing disadvantages inherent in the above-mentioned prior arts, the general purpose of the present invention is to provide an improved combination of convenience and utility, to include all the advantages of the prior arts, and to overcome the above-mentioned disadvantages/drawbacks of the prior art.

In one aspect of the present invention, a combination eating utensil comprises a first eating utensil, a second eating utensil and a third eating utensil. The first eating utensil has a first section and a second section, the second section having a width greater than a width of the first section. The second eating utensil has a first section and a second section, the second section of the second eating utensil having a width greater than a width of the first section of the second eating utensil. The second eating utensil is mechanically coupled to at least a portion of the first eating utensil to form a receiving space therebetween. The third eating utensil is disposed in the receiving space and mechanically coupled to the first and the second eating utensils.

In another aspect of the present invention, a combination eating utensil comprises a first eating utensil, a second eating utensil. The first eating utensil has a first chopstick section and a fork section, the fork section having a width greater than a width of the first chopstick section. The second eating utensil has a second chopstick section and a spoon section, the spoon section having a width greater than a width of the second chopstick section. The spoon section mechanically coupled to at least a portion of the first chopstick section and the fork section mechanically coupled to at least a portion of the second chopstick section to form a receiving space therebetween. The third eating utensil has a handle section and a blade section. The third eating utensil is disposed in the receiving space and mechanically coupled to the first and the second eating utensil.

In yet another aspect of the present invention, a combination eating utensil comprises a chopstick-fork eating utensil, a chopstick-spoon eating utensil and a knife. The chopstick-fork eating utensil has a first chopstick section and a fork section, the fork section having a width greater than a width of the first chopstick section. The chopstick-spoon eating utensil has a second chopstick section and a spoon section, the spoon section having a width greater than a width of the second chopstick section. The spoon section is mechanically coupled to at least a portion of the first chopstick section and the fork section is mechanically coupled to at least a portion of the second chopstick section to form a receiving space therebetween. The knife has a handle section and a blade section. The knife is disposed in the receiving space and is mechanically coupled to the chopstick-fork and the chopstick-spoon eating utensils.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a top view of a combination eating utensil 100, according to an exemplary embodiment of the present invention;

FIG. 1A is a top view illustrates the first eating utensil 20 and the second eating utensil 40 in partial contact with each other;

FIG. 2 is a top view of the combination eating utensil 100 in a disassembled state, according to an exemplary embodiment of the present invention;

FIG. 3 is a perspective view of the first eating utensil 20, according to an exemplary embodiment of the present invention;

FIG. 4 is a perspective view of the second eating utensil 40, according to an exemplary embodiment of the present invention; and

FIG. 5 is a perspective view of the third eating utensil 60, according to an exemplary embodiment of the present invention.

Like reference numerals refer to like parts throughout several views of the drawings.

### DETAILED DESCRIPTION OF THE INVENTION

The exemplary embodiments described herein detail for illustrative purposes are subject to many variations in structure and design. It should be emphasized, however that the present invention is not limited to a particular combination eating utensil shown and described. Rather, the principles of the present invention can be used with a variety of combination eating utensil configurations and structural arrangements, e.g., for aesthetics, structural purposes, and/or for simplicity in shipping and storage. It is understood that various omissions, substitutions of equivalents are contemplated as circumstances may suggest or render expedient, but is intended to cover the application or implementation without departing from the spirit or scope of the claims of the present invention.

The present invention provides a combination eating utensil that is a combination of various eating utensils, which upon disassembling can be used as individual eating utensils, and more specifically, to a combination eating utensil that can be used as chopsticks, a knife, a fork and a spoon and thus obviating need to carry all the units separately. Also, the combination eating utensil is capable of being disassembled easily by the user without the need of any special equipment, skill or assistance by third party. The combination eating utensil may be suitably used in fast food places, restaurants, eating joints, and the like; and outdoors in picnics, camps, and the like thereby serving the commercial viability of a single multi-purpose combination eating utensil overcoming all the existing drawbacks. Although it is envisioned that the various eating utensils can be disposed after a single use, the eating utensils can be re-assembled and used multiple times.

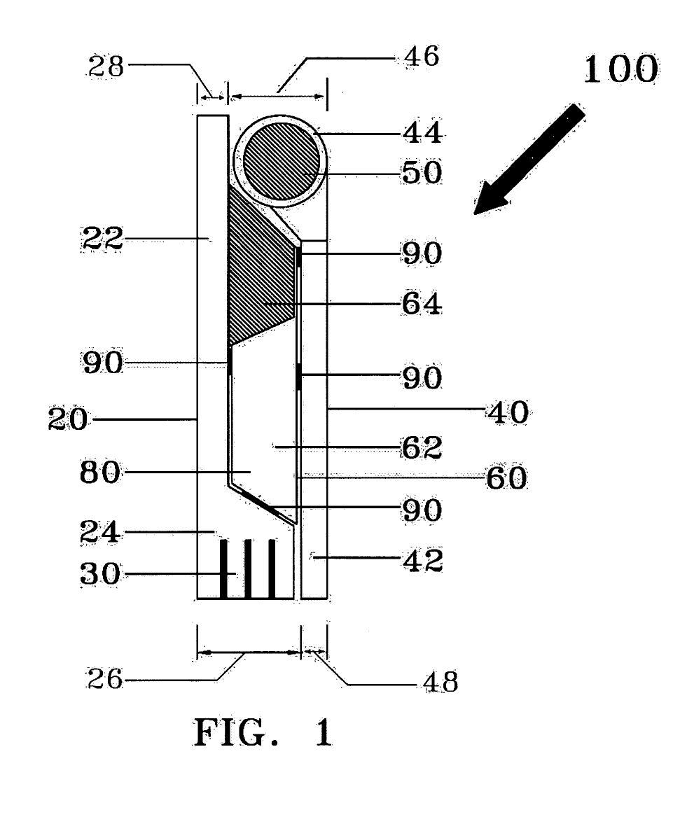

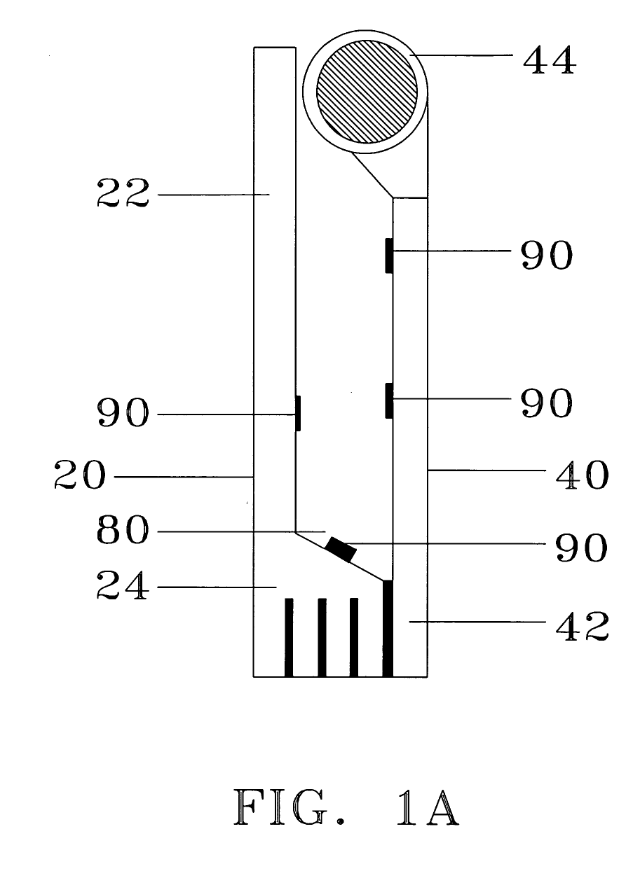

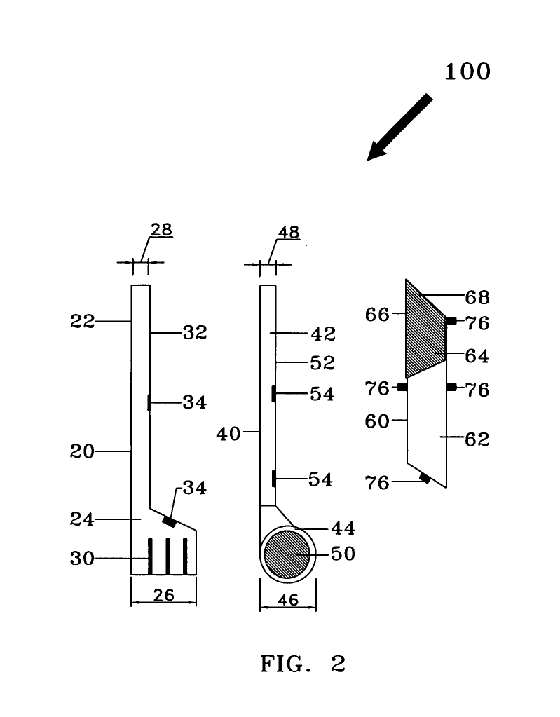

Referring now to FIGS. 1 and 2, in one embodiment, a combination eating utensil 100 comprises a first eating utensil 20 having a first chopstick section 22 and a fork section 24; a second eating utensil 40 having a second chopstick section 42 and a spoon section 44; and a third eating utensil 60, e.g., a knife having a handle section 62 and a blade section 64.

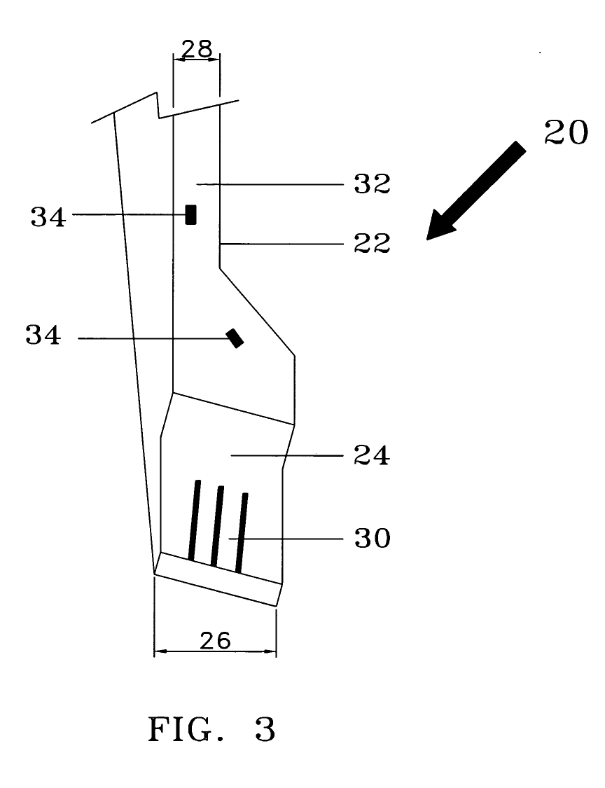

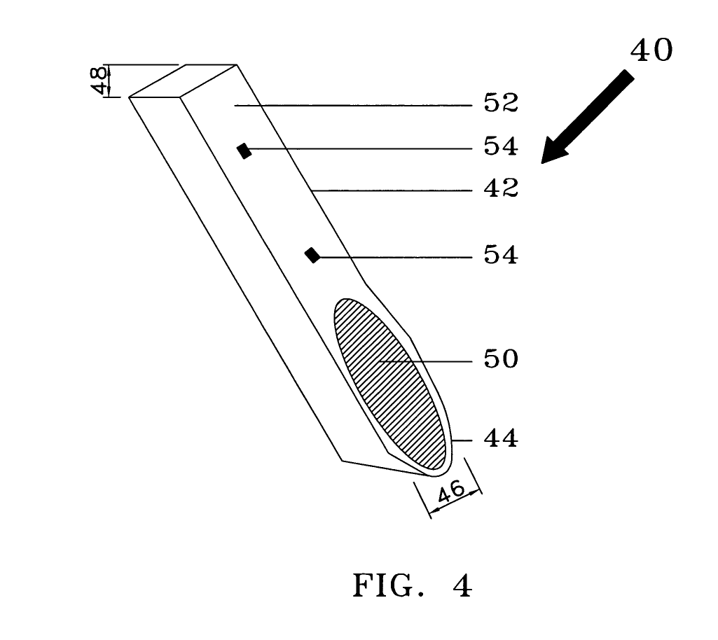

FIGS. 3 and 4 illustrate perspective views of the first eating utensil 20 and the second eating utensil 40. The first chopstick section 22 and the second chopstick section 42 have a shape that preferably is in the form of squared or cylindrical cross sectional bodies, extending from the fork section 24 and the spoon section 44, respectively. Preferably, the first chopstick section 22 and the second chopstick section 42 are contoured (i.e., shaped to be easily grasped by a user).

The fork section 24 has a plurality of prongs 30 for engaging food, while the spoon section 44 has a scoop 50 for engaging food. The fork section 24 and spoon section 44 can have any shape, such that, mechanical coupling of the spoon section 44 to at least a portion of the first chopstick section 22 and mechanical coupling of the fork section 24 to at least a portion of the second chopstick section 42 forms a receiving space 80 (See FIG. 1) between the first eating utensil 20 and the second eating utensil 40. For example, the first eating utensil 20 has an inner wall 32 that extends outwards at the fork section 24, such that, the fork section 24 has a width 26 greater than a width 28 of the first chopstick section 22. Similarly, the second eating utensil has an inner wall 52 that extends outwards at the spoon section 44, such that, the spoon section 44 has a width 46 greater than a width 48 of the second chopstick section 48.

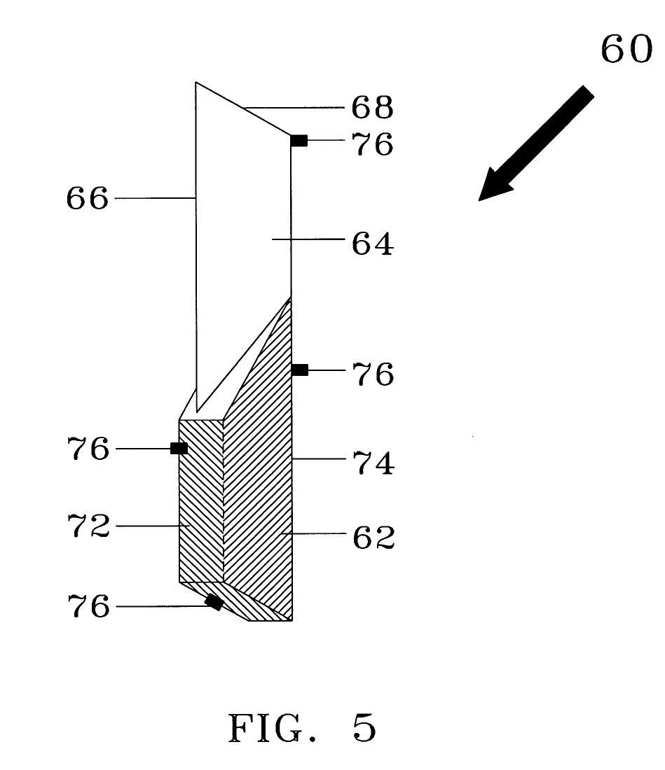

Referring to FIG. 5, the handle section 62 of the third eating utensil 60 is preferably contoured, such that, the third eating utensil 60 can be firmly grasped at the handle section 62, and thereby preventing the user's hand from slipping off the handle section 62 and thus providing protection against the user cutting their hand on the blade section 64. The blade section 64 extends from the handle section 62 and has cutting edges 66 and 68 for cutting the food.

The third eating utensil 60 is disposed in the receiving space 80 and is mechanically coupled to the first eating utensil 20 and the second eating utensil 40 by way of a plurality of connection means 90. The connection means 90 comprise structural features disposed on the third eating utensil 60 that removably engage with complementary structural features disposed on the first eating utensil 20 and second eating utensil 40. For example, as illustrated in FIGS. 1-5, the third eating utensil 60 can have insert posts 76, protrusions, ribs, and/or the like disposed on a first side wall 72 and on the second side wall 74 that removably engage with insert holes 34, 54 on inner walls 32, 52 of the first eating utensil 20 and the second eating utensil 40, respectively.

The structural features (like, insert posts 76) and the complementary structural features (like, insert holes 34, 54) may be interchangeably disposed on the first, the second and the third eating utensils 20, 40, 60. Furthermore, in an additional embodiment, the first eating utensil 20 may also be connected to the second eating utensil 40 by way of a plurality of connection means, similar to the connection means 90. For example, the first eating utensil 20 and the second eating utensil 40 are connected to each other at the portions where the spoon section 44 contacts the first chopstick section 22; and where the fork section 24 contacts the second chopstick section 42.

The combination eating utensil 100 can be disassembled by snapping the connection means 90 to separate the first eating utensil 20, the second eating utensil 40 and third eating utensil 60, to facilitate the user to use the eating utensils individually to cut or engage the food, or, in combination in order to cut and engage the food at the same time.

In one embodiment, the first eating utensil 20 can be used a fork and the second eating utensil 40 can be used as a spoon. In this embodiment, the user's hand grips the first chopstick section 22 with the fork section 24 facing downwardly to use the fork section 24 for engaging food; and the user's hand can grip the second chopstick section 42 with the spoon section 44 facing downwardly to use the spoon section 44 for engaging food. In another embodiment, the user's hand can grip the fork section 24 and the spoon section 44 with the first chopstick section 22 and the second chopstick section 42 facing downwardly for engaging food as a conventional pair of chopsticks.

Individual eating utensils (i.e., first eating utensil 20, second eating utensil 40 second and third eating utensil 60) in the combination eating utensil 100 can be made from any material that provides strength, easy graspability, light-weight and support for the user. The material should be rigid enough for retaining food and flexible enough, such that, the individual eating utensils can be easily disassembled from the combination eating utensil 100; and reassembled in case of non-disposable eating utensils. Exemplary materials include, but are not limited to, plastic, metal, wood, and so forth. In an exemplary embodiment of the present invention, the device is disposable.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

1. A combination eating utensil comprising:
a first eating utensil having a first section and a second section, said second section having a width greater than a width of said first section;
a second eating utensil having a first section and a second section, said second section having a width greater than a width of said first section, said second eating utensil mechanically coupled to at least a portion of said first eating utensil to form a receiving space therebetween; and
a third eating utensil disposed in said receiving space and mechanically coupled to said first and said second eating utensils.

2. A combination eating utensil comprising:
a first eating utensil having a first chopstick section and a fork section, said fork section having a width greater than a width of said first chopstick section;
a second eating utensil having a second chopstick section and a spoon section, said spoon section having a width greater than a width of said second chopstick section, said spoon section mechanically coupled to at least a portion of said first chopstick section and said fork section mechanically coupled to at least a portion of said second chopstick section to form a receiving space therebetween; and
a third eating utensil having a handle section and a blade section, said third eating utensil disposed in said receiving space and mechanically coupled to said first and said second eating utensils.

3. The combination eating utensil of claim 2 wherein mechanical coupling of said first, said second and said third eating utensils is by way of a plurality of connection means.

4. The combination eating utensil of claim 3, wherein said connection means comprise structural features disposed on said third eating utensil and complementary structural features disposed on said first and second eating utensils, said structural features removably engage with said complementary structural features.

5. The combination eating utensil of claim 4, wherein said structural features are disposed on a first side wall and a second side wall of said handle section of said third eating utensil.

6. The combination eating utensil of claim 4, wherein said complementary structural features are disposed on inner walls of said first and second eating utensil.

7. The combination eating utensil of claim 4, wherein said structural features may include protrusions, ribs, posts, and combinations of the foregoing.

8. The combination eating utensil of claim 4, wherein said complementary structural features may include grooves, holes, slots and combinations of the foregoing.

9. The combination eating utensil of claim 2, wherein a user's hand grips said first chopstick portion with said fork section facing downwardly to use said fork section for engaging food, and wherein, said user's hand grips said second chopstick section with said spoon section facing downwardly to use said spoon section for engaging food.

10. The combination eating utensil of claim 2, wherein a user's hand grips said fork section and said spoon section with said first and second chopstick sections facing downwardly for engaging food.

11. A combination eating utensil, comprising:
a chopstick-fork eating utensil having a first chopstick section and a fork section, said fork section having a width greater than a width of said first chopstick section;
a chopstick-spoon eating utensil having a second chopstick section and a spoon section, said spoon section having a width greater than a width of said second chopstick section, said spoon section mechanically coupled to at least a portion of said first chopstick section and said fork section mechanically coupled to at least a portion of said second chopstick section to form a receiving space therebetween; and
a knife having a handle section and a blade section, said knife being disposed in said receiving space and mechanically coupled to said chopstick-fork and said chopstick-spoon eating utensils.

12. The combination eating utensil of claim 11 wherein mechanical coupling of said chopstick-fork, said chopstick-spoon eating utensils and knife is by way of a plurality of connection means.

13. The combination eating utensil of claim 12, wherein said connection means comprise structural features disposed on said knife and complementary structural features disposed on said chopstick-fork eating utensil and said chopstick-spoon eating utensil, said structural features removably engage with said complementary structural features.

14. The combination eating utensil of claim 13, wherein said structural features and said complementary structural features may be interchangeably disposed on said first, said second and said third eating utensils.

15. The combination eating utensil of claim 13, wherein said structural features are disposed on a first side wall and a second side wall of said handle section of said knife.

16. The combination eating utensil of claim 13, wherein said complementary structural features are disposed on inner walls of said chopstick-fork eating utensil and said chopstick-spoon eating utensil.

17. The combination eating utensil of claim 13, wherein the structural features may include protrusions, ribs, posts, and combinations of the foregoing.

18. The combination eating utensil of claim 13, wherein said complementary structural features may include grooves, holes, slots and combinations of the foregoing.

19. The combination eating utensil of claim 11, wherein a user's hand grips said first chopstick portion with said fork section facing downwardly to use said fork section for engaging food, and wherein, said user's hand grips said second chopstick section with said spoon section facing downwardly to use said spoon section for engaging food.

20. The combination eating utensil of claim 11, wherein a user's hand grips said fork section and said spoon section with said first and second chopstick sections facing downwardly for engaging food.
